(19) United States
(12) Patent Application Publication
(10) Pub. No.: US 2007/0040866 A1
(43) Pub. Date: Feb. 22, 2007

(54) Droplet ejecting nozzle plate and manufacturing method therefor

(75) Inventors: Norikuni Funatsu, Kanagawa (JP); Hiroshi Inoue, Kanagawa (JP); Hideki Fukunaga, Kanagawa (JP); Masaki Kataoka, Kanagawa (JP); Hiroyuki Usami, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/347,519

(22) Filed: Feb. 4, 2006

(30) Foreign Application Priority Data
Aug. 22, 2005 (JP) 2005-240123

(51) Int. Cl. B41J 2/16

(52) U.S. Cl. 347/47

(57) ABSTRACT

A manufacturing method for a droplet ejecting nozzle plate comprising: providing a nozzle plate layered body which includes a metal film positioned on a sheet material, a water-repellant layer positioned on the metal film; forming a nozzle hole at a present position in the nozzle plate layered body by laser processing.

### CROSS-REFERENCE TO RELATED APPLICATION

This application claims priority under 35 U.S.C. 119 from Japanese Patent Application No.2005-240123, the disclosure of which is incorporated by reference herein.

### BACKGROUND OF THE INVENTION

1. Field of the Invention

The present invention relates to a droplet ejecting nozzle plate utilizing a droplet ejecting head that ejects droplets and records images, and to a method for manufacturing this droplet ejecting nozzle plate.

2. Description of the Related Art

There are conventional inkjet recording apparatuses where droplet ejecting devices eject droplets from multiple nozzles and perform printing on recording media such as paper. These inkjet recording devices have various benefits, such as being compact, affordable and quiet, and are thus widely sold on the market Piezo inkjet-type recording devices, where piezoelectric elements are used to change pressure in pressure chambers and eject ink droplets, as well as thermal inkjet-type recording devices, where ink is expanded with the action of thermal energy and ink droplets ejected, have especially many benefits. These include, among others, high-speed and high-resolution printing.

With these types of inkjet recording devices, water-repellant layers are coated on the multiple nozzle surfaces to prevent ink droplets from sticking to the peripheries of the nozzles when ink droplets are ejected from the nozzles. Nonetheless, the adhesion of these water-repellant layers is generally weak, and thus they tend to peel when performing blade wiping and the like at the time of machine maintenance.

Here, in the technology recited in the Official Gazette of Japanese Application Laid-Open (JP-A) No. 11-188879, a thin metal film is layered on a resin layer film, and a water-repellant layer is formed on the surface of the thin metal film. The adhesion qualities of the water-repellant layer are strengthened by forming the water-repellant layer via the metal film, as compared to when the water-repellant layer is formed without a metal film. Nonetheless, in this technology, formation of the nozzle holes is performed by forming a resist pattern on the thin metal film layer after which etching is performed. Accordingly, more manufacturing steps are required.

### SUMMARY OF THE INVENTION

The present invention was created in light of the above-described circumstances, and provides a droplet ejecting nozzle plate where the adhesion of the water-repellant layer is high and the plate can be manufactured with ease. Also, the present invention provides a method for manufacturing this droplet ejecting nozzle plate.

The manufacturing method for a droplet ejecting nozzle plate according to a first embodiment is a method comprising: providing a nozzle plate layered body which includes a metal film positioned on a sheet material, a water-repellant layer positioned on the metal film; forming a nozzle hole at a present position in the nozzle plate layered body by laser processing.

With the above-described method, the sheet material, the metal film, and the water-repellant layer are positioned in this order. The nozzle hole is formed at once with laser processing so steps where a pattern resist is formed and peeled become unnecessary and the manufacturing process can be simplified.

Further, the water-repellant layer is formed via the metal film so, when compared to when the water-repellant layer is formed without a metal film, the adhesion qualities can be improved.

The droplet ejecting nozzle plate of a second embodiment of the present invention comprises a sheet material, a metal film layered on the sheet material, a water-repellant layer formed on the metal film, and a nozzle hole that communicates the sheet material, the metal film, and the water-repellant layer. The nozzle wall comprising the nozzle hole of the metal film is exposed by the nozzle hole.

With the droplet ejecting nozzle plate configured as described above, the nozzle wall of the metal film is exposed by the nozzle hole and is not covered by the water-repellant layer. Accordingly, a step for covering the nozzle wall with the water-repellant layer is not necessary and the manufacturing steps can be simplified.

Further, with a step in which the nozzle wall of the metal film is covered by the water-repellant layer, water repellant has a tendency of entering into the ink channel further in than the metal film, so this problem does not occur with the above-described configuration.

### BRIEF DESCRIPTION OF THE DRAWINGS

Preferred embodiments of the present invention will be described in detail based on following figures, wherein:

FIG. 1 is a cross-sectional drawing showing the inkjet recording head of the present embodiment;

FIGS. 2A-2G are drawings explaining the manufacturing process for the nozzle plate of the present embodiment;

FIG. 3 is a chart of the physical properties of metals that can be selected as the materials for the metal film of the present embodiment; and

FIGS. 4A-4E are drawings explaining another manufacturing process for the nozzle plate of the present embodiment.

### DETAILED DESCRIPTION OF THE INVENTION

Next, the embodiments of the present invention will be explained in detail based on the drawings.

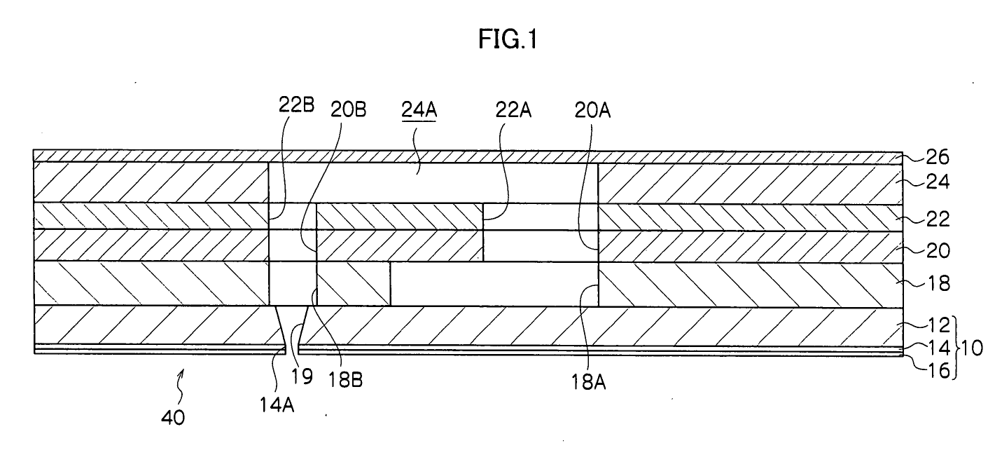

FIG. 1 is a cross-sectional drawing showing an inkjet recording head 40 of the present embodiment.

As shown in FIG. 1, the inkjet recording head 40 comprises a nozzle plate 10, a pool plate 18, channel plates 20 and 22, a pressure chamber plate 24, and an vibration plate 26 layered in that order.

The nozzle plate 10 is configured to have a water-repellant layer 16, a metal film 14, and a sheet material 12 layered in that order from the ink ejecting surface side.

An ink pool 18A that retains ink and a through-port 18B that ejects ink are formed in the pool plate 18. Ink is supplied to the ink pool 18A from an ink tank (not shown).

The channel plate 20 is joined to the pool plate 18 at the side opposite to the side where the ink is ejected. The upper side of the ink pool 18A is formed from the channel plate 20. A channel 20A, through which the ink pool 18A and a pressure chamber 24A (to be described later) are communicated, and a connection port 20B, through which the pressure chamber 24A and the through-port 18B are communicated, are formed in the channel plate 20.

The channel plate 22 is joined to the channel plate 20 and the bottom side of the pressure chamber 24A is formed by the channel plate 22. A channel 22A, through which the ink pool 18A and the pressure chamber 24A are communicated, and a connection port 22B, through which the pressure chamber 24A and the through-port 18B are communicated, are formed in the channel plate 22.

The pressure chamber plate 24 is joined to the channel plate 22 and the pressure chamber 24A is formed in the pressure chamber plate 24. The pressure chamber 24A is formed one per nozzle 19, which will be described later.

The ink accumulated in the ink pool 18A reaches the pressure chamber 24A through the channels 20A and 22A, and is ejected from the pressure chamber 24A through the connection ports 22B and 20B, the through-port 18B, and the nozzle 19.

The vibration plate 26 is arranged on the upper side of the pressure chamber plate 24. The vibration plate 26 is exposed by the pressure chamber 24A at the portion where the pressure chamber 24A is formed, and the vibration plate 26 comprises a portion of the pressure chamber 24A. An actuator, which has been omitted from the drawings, is provided on the vibration plate 26.

The sheet material 12 is layered under the pool plate 18 at the side from which ink is ejected, the metal film 14 is layered under the sheet material 12, and the water-repellant layer 16 is layered under the metal film 14. Holes are provided in the sheet material 12, the metal film 14, and the water-repellant layer 16 at positions corresponding to the through-port 18B, whereby the nozzle 19 is formed. Water-repellant processing is not performed on the side walls of the metal film 14 forming the nozzle 19, hereafter referred to as “nozzle wall 14A”, which is exposed through the nozzle 19.

Next, the manufacturing method for the nozzle plate 10 forming the above-described inkjet recording head 40 will be explained.

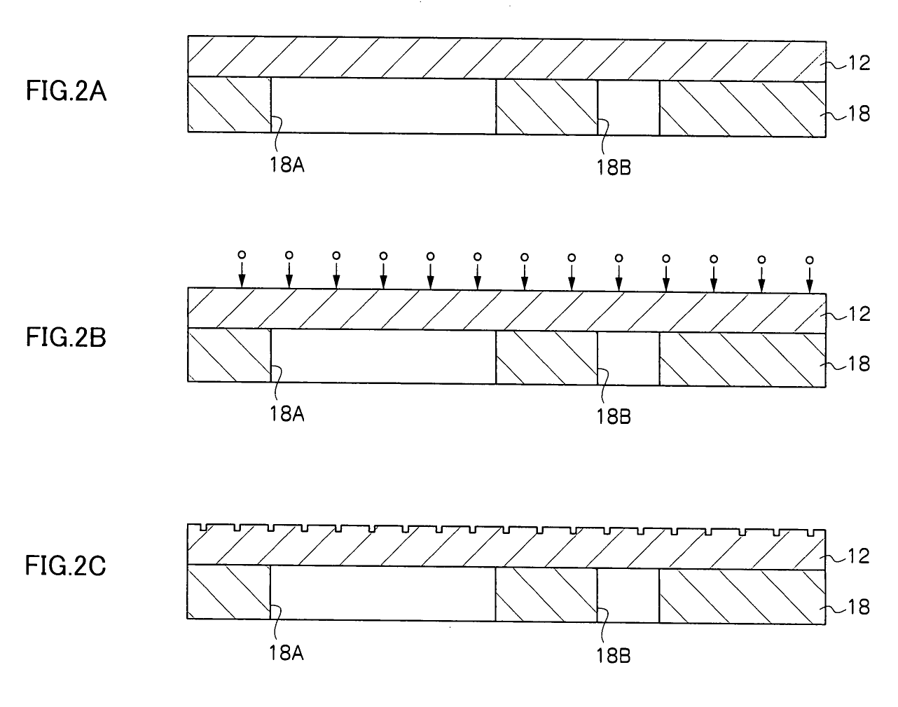

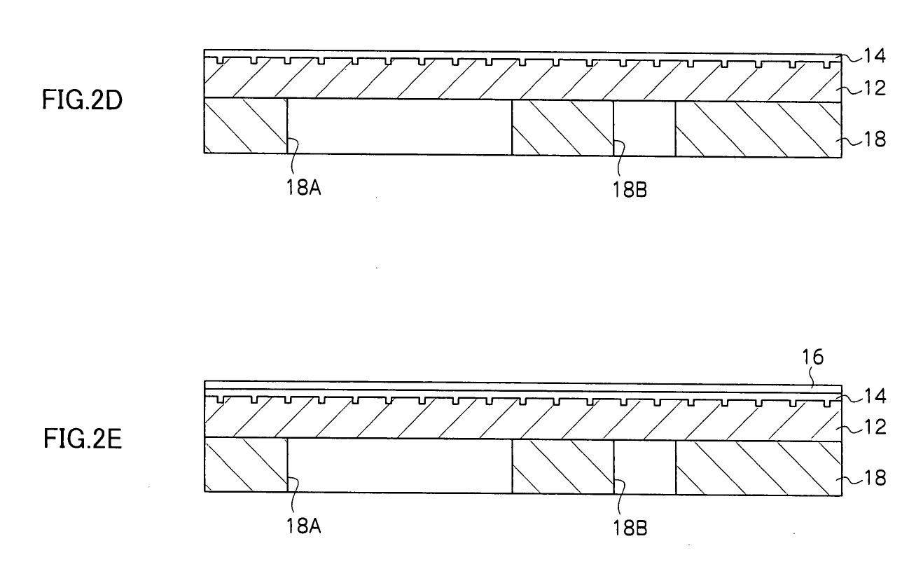

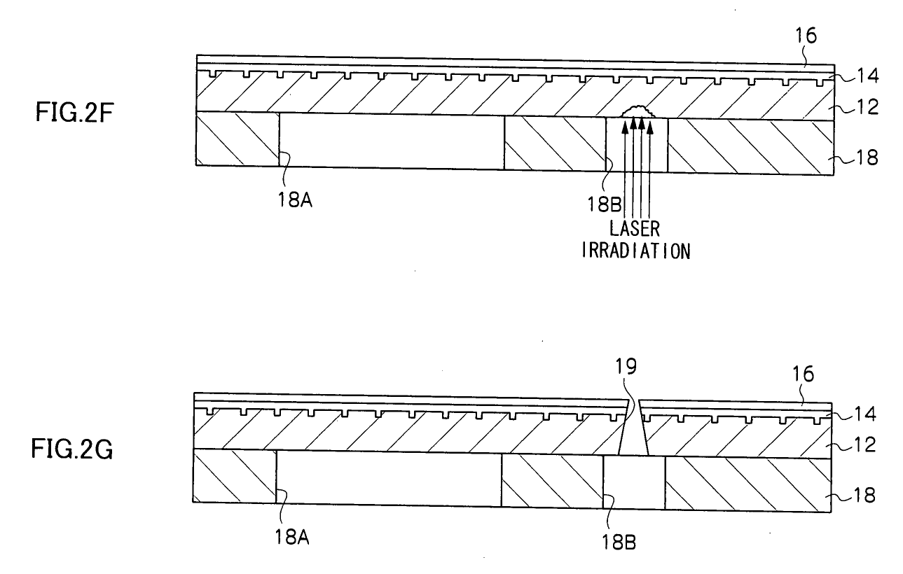

First, as shown in FIG. 2A, the pool plate 18 and the sheet material 12 are joined. The ink pool 18A and through-port 18B are formed in the pool plate 18 in advance. An SUS can be used for the pool plate 18 and a resin film such as a polyimide film can be used for the sheet material 12.

Next, as shown in FIG. 2B, oxygen plasma treatment is performed on the sheet material 12. Due to this, the surface of the sheet material 12 is roughened and, as shown in FIG. 2C, irregularities are formed thereon. It should be noted that in place of oxygen plasma treatment, irregularities can be formed on the surface of the sheet material 12 with etching or ashing.

Next, as shown in FIG. 2D, the metal film 14 is formed on the sheet material 12. The metal film 14 can be formed with any number of methods including sputtering, vapor deposition, and plating. In light of factors such as laser processing and the like, which will be described later, it is preferable that the film thickness of the metal film 14 be between 5 nm-50 nm. When the film is thinner than 5 nm, the adhesion qualities of the metal film with the water-repellant layer 16 is lowered and when thicker than 50 nm, it becomes difficult to form and provide holes with laser processing. Further, in laser processing, it is necessary that the film thickness be made such that excessive heat energy is not consumed so from this point as well, it is preferable that the film be less than 50 nm.

It is preferable that the metal comprising the metal film 14 have good compatibility with the sheet material 12 and the water-repellant layer 16. When the water-repellant layer 16 is formed on a polyimide sheet, examples of materials having good compatibility include copper (Cu), aluminum (Al), etc.

Further, in order to prevent deformation or alteration of the sheet material 12 by the heat generated with the laser processing that will be described later, it is preferable that a metal having a low rate of heat conduction be used. Specific examples of metals having heat conduction lower than silicon include titanium (Ti), ruthenium (Ru), tantalum (Ta), nickel (Ni) and tin (Sn).

Specific metal film thickness values are shown below as examples. When the metal film 14 is made from titanium (Ti), it is preferable that the film thickness be between 11.40 nm-17.40 nm; when using ruthenium (Ru), it is preferable that the film thickness of the metal film 14 be between 11.68 nm-13.64 nm; and when using tantalum (Ta), it is preferable that the film thickness of the metal film 14 be between 15.37 nm-21.25 nm. However, the present invention is not limited to these thicknesses, and with regard factors such as laser processing, it is preferable that the thickness be made between 5 nm-50 nm.

Further, it is preferable that the linear expansion coefficient of the metal film be either equal to or less than that of the polyimide film and higher than a silicon oxidation film. Shearing stress due to heat expansion can be alleviated and peeling due to deviations prevented by using a metal that can follow the growth that accompanies thermal expansion of the polyimide film used for the sheet material 12.

It should be noted that specific examples of polyimide films include Upilex-25S made by Ube Industries, Ltd. and Kapton 100EN made by DuPont-Toray Co., Ltd. The rate of heat conduction and linear expansion coefficient for each of these are as follows:

| | | | |
|---|---|---|---|
| Upilex-25S: | Rate of heat conduction: | 0.29 | W/(m × K) |
| | Rate of linear expansion: | 12 | ppm/K |
| Kapton 100EN: | Rate of heat conduction: | 0.12 | W/(m × K) |
| | Rate of linear expansion: | 16 | ppm/K |

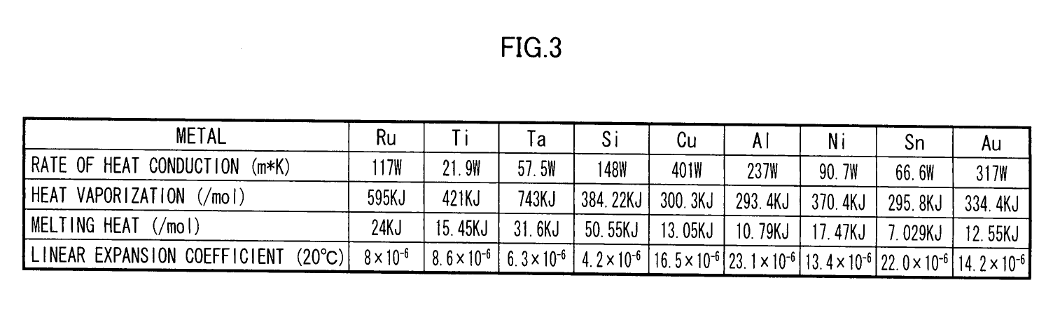

The heat conduction rates, heat evaporation, melting heats, and linear expansion coefficients for ruthenium, titanium, tantalum, copper, aluminum, nickel, tin, gold, and silicon are shown in the chart in FIG. 3.

Next, as shown in FIG. 2E, the water-repellant layer 16 is formed on the surface of the metal film 14. Formation of the water-repellant layer 16 can be performed with vapor deposition or spin-coating methods. It should be noted that the water-repellant layer 16 can be formed with a fluorine series resin and that it is preferable that the film thickness be 600 nm-1000 mn.

Then, as shown in FIG. 2F, lasers are irradiated from the through-port 18B side of the pool plate 18 and the nozzle 19 is formed by opening a hole through the sheet material 12, the metal film 14, and the water-repellant layer 16 in the positions that correspond to the through-port 18B. Due to this, as shown in FIG. 2G; the nozzle plate 10 is formed. Excimer laser processing can be used for the laser processing.

With the present embodiment, the nozzle is formed at once with laser processing through the sheet material 12, the metal film 14, and the water-repellant layer 16. Accordingly, when compared to cases where masking and the like of the metal film is performed and holes are provided through metal etching, the manufacturing steps are reduced and the nozzle plate can be produced more easily.

Further, the hole for the nozzle 19 is provided after formation of the water-repellant layer 16 so water repellant does not enter in from the through-port 18B side, unlike cases where the water-repellant layer 16 is formed in a state where a nozzle hole is formed in the metal film 14.

Moreover, since nozzle formation is performed with laser processing, it is easy to realize the desired nozzle diameter by adjusting the diameter of the laser.

Further, the nozzle plate 10 has the metal film 14 so the adhesion between it and the water-repellant layer 16 is improved. Furthermore, by providing the metal film 14, cavitation vibration from the orifice is dampened, so the reliability of the water-repellant layer 16 can be improved while increasing its life.

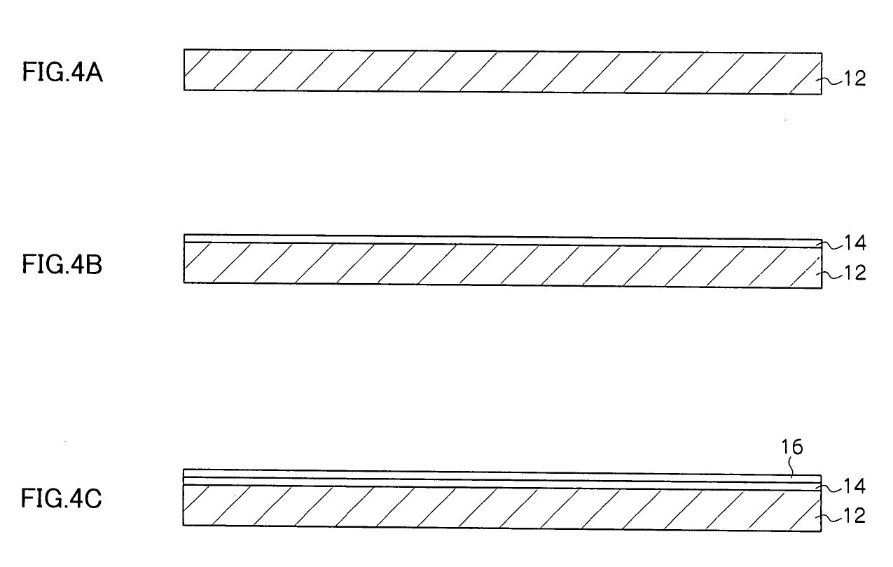

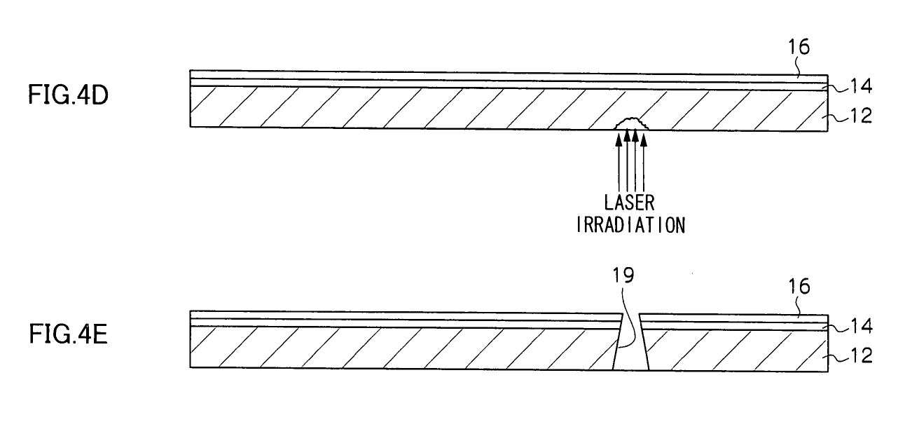

It should be noted that with the present embodiment, the metal film 14 and water-repellant layer 16 were layered on the sheet material 12 after the sheet material 12 was layered on the pool plate 18 and then the hole for the nozzle 19 was provided. However, the metal film 14 and water-repellant layer 16 can be layered on the sheet material 12 without the pool plate 18 after which the hole for the nozzle 19 can be provided. In this case, after the metal film 14 is layered on the sheet material 12 shown in FIG. 4A, the water-repellant layer 16 is formed (see FIG. 4C) and then lasers are irradiated from the sheet material 12 side (see FIG. 4D) and the nozzle 19 is provided at the desired nozzle position (see FIG. 4E).

It should be noted that the present embodiment was explained where the nozzle plate 10, which is a comprising component of the inkjet recording head 40, acts as the droplet ejecting nozzle plate, however, the present invention is not limited to the inkjet recording head described above. The present invention can also be applied to nozzle plates for other droplet ejecting heads, such as those used with pattern-forming devices that eject droplets for forming patterns on devices such as semiconductors.

As explained above, the manufacturing method for the droplet ejecting nozzle plate of the present invention involves layering a metal film on a sheet material and layering a water-repellant layer on the metal film. The nozzle plate layer body is formed and a nozzle hole is provided at a preset position in the nozzle plate layer body with laser processing.

With the above manufacturing method for the droplet ejecting nozzle plate, the sheet material, metal film, and water-repellant layer are layered in this order, and the nozzle hole is opened at once with laser processing. Steps for resist pattern formation and peeling are thus unnecessary and the plate can be manufactured with ease.

Further, the water-repellant layer is formed via the metal film so the adhesion characteristics of the water-repellant layer can be increased compared to when a metal film is not used.

It should be noted that with the above manufacturing method for the droplet ejecting nozzle plate, the sheet material can be layered on a through-port plate in which a through-ports for ejecting droplets is formed. The nozzle hole can be opened and provided at a position that corresponds to the through-port of the nozzle plate layered body.

By layering the sheet material on the through-port plate in advance, the through-port plate functions as a substrate so subsequent steps can be more easily performed.

Further, the above manufacturing method for the droplet ejecting nozzle plate can be characterized in that the lasers from laser processing are irradiated from the sheet material side.

In this manner, the nozzle hole can be easily opened and provided by laser irradiation from the sheet material side without the need for resists and the like.

Further, the above manufacturing method for the droplet ejecting nozzle plate can be characterized in that the film thickness of the metal film is 5 nm or more and 50 nm or less.

When the film thickness of the metal film is thinner than 5 nm, its adhesion to the water-repellant layer deteriorates. When the film thickness of the metal film is thicker than 50 nm, laser processing becomes difficult. Accordingly, it is preferable that the thickness of the metal film be within the above-described range.

Further, the above manufacturing method for the droplet ejecting nozzle plate can also be characterized in that surface treatment of the sheet component is performed prior to layering the metal film.

The adhesion characteristics of the metal film to the sheet material can be increased by such surface treatment of the sheet component.

Moreover, the above manufacturing method for the droplet ejecting nozzle plate can be characterized in that the metal film can be formed with a sputtering method.

A metal film with high adhesion qualities can be formed using a sputtering method.

Further, the above manufacturing method for the droplet ejecting nozzle plate can also be characterized in that a metal can be used so that the rate of heat conduction for the metal film is lower than that of silicon.

When the rate of heat conduction is high, there is a possibility of the sheet material deforming or altering due to the heat generated at the time of laser processing. Accordingly, as described above, it is preferable that the rate of heat conduction be lower than that of silicon.

Moreover, the above manufacturing method for the droplet ejecting nozzle plate can be characterized in that the linear expansion coefficient of the metal film is higher than a silicon oxidation film.

When the linear expansion coefficient of the metal film is lower than that of the sheet material, shearing stress from heat expansion is generated and it is possible that peeling will occur due to deviations. For this reason, it is preferable that the metal film have a linear expansion coefficient that can follow the growth accompanying thermal expansion of the sheet material.

Further, the manufacturing method for the droplet ejecting nozzle plate can be characterized in that the water-repellant layer is a fluorine series resin.

The droplet ejecting nozzle plate of a second embodiment of the present invention comprises a sheet material, a metal film layered on the sheet material, a water-repellant layer formed on the metal film, and a nozzle hole that communicates the sheet material, the metal film, and the water-repellant layer. The nozzle wall comprising the nozzle hole of the metal film is exposed by the nozzle hole.

With the droplet ejecting nozzle plate configured as described above, the nozzle wall of the metal film is exposed by the nozzle hole and is not covered by the water-repellant layer. Accordingly, a step for covering the nozzle wall with the water-repellant layer is not necessary and the manufacturing steps can be simplified.

Further, with a step in which the nozzle wall of the metal film is covered by the water-repellant layer, water repellant has a tendency of entering into the ink channel further in than the metal film, so this problem does not occur with the above-described configuration.

### EXAMPLES

Next, examples regarding the formation of the metal film 14 explained in the above embodiments will be described.

With the conditions shown in the following Chart 1, each of titanium (Ti), tantalum (Ta), and ruthenium (Ru) were applied as films with sputtering on a polyimide sheet. An appropriate film thickness of the metal film is necessary for ensuring the adhesion qualities and also makes the providing of holes possible with lasers. Consideration was given to reduce excessive consumption of heat energy, whereby a thickness of 20 nm was sought. The film thicknesses formed with six experiments and their averages are shown in Chart 2 below. A Tokuda CFS-8EP was used as the sputtering device.

CHART 1

Material

| | Ti | Ta | Ru 99.8% |
|---|---|---|---|
| Back Pressure (Torr) | 3.6 × 10⁻⁶ | 3.7 × 10⁻⁶ | 4.0 × 10⁻⁶ |
| Target Material | Ti | Ta | Ru |
| Target No. | 1 | 3 | 1 |
| Gas | Ar | Ar | Ar |
| Flow Rate (SCCM) | 40/(200) | 55/(273) | 53/(264) |
| Pressure (m Torr) | 4 | 6 | 6(5.7) |
| Power (A or KW) | 2 A/287 V | 2 A/310 V | 2 A/370 V |
| Sub Temp (° C.) | RT | RT | RT |
| Sputter Time (min.) | 43 sec. | 45 sec. | 45 sec. |
| Pre-Sputter (min.) | 3 min. | 3 min. | 10 min. |

| | CHART 2 | | |
|---|---|---|---|
| | Material | | |
| | Ti | Ta | Ru |
| Thickness (nm) | 17.00 | 15.37 | 13.64 |
| | 16.94 | 18.04 | 12.48 |
| | 12.51 | 21.25 | 12.09 |
| | 17.40 | 19.42 | 11.73 |
| | 12.46 | 20.80 | 11.68 |
| | 13.57 | 20.21 | 11.86 |
| Average | 14.98 | 19.18 | 12.25 |

In evaluations of the adhesion strengths of the formed metal films, it was found that the adhesion strength of ruthenium was highest, followed by tantalum, and the metal with the lowest adhesion strength was titanium (according to fluid contact tests with ink and supersonic wave acoustic stress tests). With regard to SiO, a SiO film was similarly formed and its adhesion strength was found to be about the same as that of titanium.

Next, examples of surface treatments of the polyimide film forming the sheet material 12 will be explained.

Oxygen plasma treatment was performed on the surface of the polyimide film under the conditions thrown in the following Chart 3. A Technics Micro-RIE was used as the plasma device. The results, as shown in Chart 4, indicate that in evaluations of droplet stationary angle of contact, improvements of about 67°-76° and better hydrophilic qualities were exhibited when oxygen plasma treatment was performed, as compared to when oxygen plasma treatment was not performed.

| | CHART 3 | |
|---|---|---|
| | Conditions | |
| Vac | 20 | min. |
| Gas | O²/200 | m Torr (Total) |
| Power | 300 | Watts |
| Time | 60 | sec. |

CHART 4
Polyimide Film Stationary Angle of Contact Eval. (Degrees)

| | Sample No. | | |
|---|---|---|---|
| | 1 | 2 | 3 |
| No Plasma Treatment | 83.1 | 80 | 86.3 |
| Plasma Treatment | 10.3 | 12.1 | 9.9 |
| Difference | 72.8 | 67.9 | 76.4 |

Further, in fluid contact tests with ink and supersonic wave acoustic stress tests, better results were also obtained when performing oxygen plasma treatment as opposed to cases where no oxygen plasma treatment was performed.

It should also be noted that cases where surface treatment was performed with a UV/O₃ wash (ozone treatment) and O₂ ashing were compared be performing the fluid contact tests with ink and supersonic wave acoustic stress tests. It was found that first oxygen plasma treatment, then O₂ ashing, then UV/O₃ wash exhibited resistances, in that order, to the effects of chemical attack and acoustic stress. It was also confirmed that strong adhesion strength was obtainable with oxygen plasma treatment.

What is claimed is:

1. A manufacturing method for a droplet ejecting nozzle plate comprising:
providing a nozzle plate layered body which includes a metal film positioned on a sheet material, a water-repellant layer positioned on the metal film;
forming a nozzle hole at a present position in the nozzle plate layered body by laser processing.

2. The manufacturing method for the droplet ejecting nozzle plate of claim 1, wherein the sheet material is layered on a through-port plate in which a through-port for ejecting droplets has been formed, and the nozzle hole is provided at a position that corresponds to the through-port of the nozzle plate layered body.

3. The manufacturing method for the droplet ejecting nozzle plate of claim 1, wherein the laser of the laser processing is irradiated from the sheet material side.

4. The manufacturing method for the droplet ejecting nozzle plate of claim 1, wherein the film thickness of the metal film is 5 nm or more and 50 nm or less.

5. The manufacturing method for the droplet ejecting nozzle plate of claim 1, wherein surface treatment is performed on the sheet material prior to layering the metal film.

6. The manufacturing method for the droplet ejecting nozzle plate of claim 1, wherein the metal film is formed with a sputtering method.

7. The manufacturing method for the droplet ejecting nozzle plate of claim 1, wherein the metal film is formed from a metal having a rate of heat conduction lower than that of silicon.

8. The manufacturing method for the droplet ejecting nozzle plate of claim 1, wherein the metal film has a linear expansion coefficient that is higher than a silicon oxidation film.

9. The manufacturing method for the droplet ejecting nozzle plate of claim 1, wherein the water-repellant layer is a fluorine series resin.

10. A droplet ejecting nozzle plate comprising:
a sheet material;
a metal film layered on the sheet material; and
a water-repellant layer formed on the metal film;
wherein a nozzle hole is formed that communicates the sheet material, the metal film, and the water-repellant layer, and a nozzle wall forming the nozzle hole of the metal film is exposed by the nozzle hole.

11. The droplet ejecting nozzle plate of claim 10, wherein the sheet material is layered on a through-port plate in which a through-port for ejecting droplets has been formed, and the nozzle hole is provided at a position that corresponds to the through-port of the nozzle plate layered body.

12. The droplet ejecting nozzle plate of claim 10, wherein the film thickness of the metal film is 5 nm or more and 50 nm or less.

13. The droplet ejecting nozzle plate of claim 10, wherein surface treatment is performed on the sheet material at the side where the metal film is layered.

14. The droplet ejecting nozzle plate of claim 10, wherein the metal film is formed from a metal having a rate of heat conduction lower than that of silicon.

15. The droplet ejecting nozzle plate of claim 10, wherein the metal film has a linear expansion coefficient that is higher than a silicon oxidation film.

16. The droplet ejecting nozzle plate of claim 10, wherein the water-repellant layer is a fluorine series resin.
